(19) United States
(12) Patent Application Publication
(10) Pub. No.: US 2005/0201075 A1
(43) Pub. Date: Sep. 15, 2005

(54) Lighting fixture

(76) Inventor: Chimanlal N. Gandhi, Brampton (CA)

Correspondence Address: CHIMANLAL N. GANDHI, c/o UNIT 33-2280 MUNN'S AVENUE, OAKVILLE, ON, L6H 3L1, CA

(21) Appl. No.: 10/735,923

(22) Filed: Dec. 16, 2003

(51) Int. Cl. F21V 7/00

(52) U.S. Cl. 362/1

(57) ABSTRACT

A lighting fixture for emitting natural and artificial light into a building comprises a main frame body, a mounting flange for mounting the main frame body onto a building, a light transmissive skylight mounted in generally overlying relation on the main frame body, a natural-light passing opening in the main frame body for permitting natural light received from the light transmissive skylight to pass through the main frame body and into the building, a first light socket operatively mounted on the main frame body for receiving an artificial light source therein, and a reflector operatively mounted on the main frame body adjacent the first light socket in overlying relation thereto, for reflecting artificial light from the artificial light source outwardly from the lighting fixture and into the building.

### FIELD OF THE INVENTION

The present invention relates to lighting fixtures, and more particularly to lighting fixtures that provide a source of sunlight and a source of artificial light.

### BACKGROUND OF THE INVENTION

Virtually all modern buildings have windows in order to permit the illumination of the interior of the building by means of sunlight. It is also increasingly common for buildings to have skylights in order to provide sufficient sunlight, or in other words natural light, during daylight hours such that little or no artificial light is required during daylight hours. In this manner, the cost of providing artificial light is minimized during daylight hours.

In most buildings, the skylights and windows are completely separate and independent from the lighting fixtures. Accordingly, there is a capital cost associated with the skylights and with the lighting fixtures. Further, there is also an installation cost associated with the skylights and with the lighting fixtures. Additionally, the location of the light entering the building from the skylight (or window) is different than the source of illumination from the artificial lighting fixture, which may be undesirable in some cases.

U.S. Pat. No. 4,114,186 issued Sep. 12, 1978 to Dominguez discloses a Lighting Fixture that provides both natural and artificial light. A hollow light duct extends through the roof of a building and has an artificial light source mounted within the hollow light duct of the lighting fixture. The essential feature of the lighting fixture of the Dominguez patent is the hingeable lid that has a reflecting surface for redirecting sunlight onto the translucent panel below it. This lid is obviously open during the day and is closed during the nighttime. The artificial light source is mounted at a vertical height below the top of the hollow light duct such that the light emanating upwardly from the artificial light source reflects off the sides of the hollow light duct, reflects off the hingeable lid, and again reflects off the sides of the hollow light duct to the bottom of the hollow light duct. Very little of this artificial light emanating upwardly from the artificial light source actually reaches the bottom of the light fixture due to the overall amount of reflection that occurs.

Further, the artificial light source is mounted at a vertical height above the bottom of the hollow light duct such that it is significantly recessed. A double pane device is immediately below the artificial light source and a light defusing panel is immediately below the double pane device. Accordingly, the artificial light source is substantially inaccessible. Further, there is no reflector immediately above the artificial light source, which reflector is standard on ceiling light fixtures in order to maximize the amount of light projected into a room in the interior of a building. It can therefore be seen that this lighting fixture is extremely inefficient at providing artificial light.

In the lighting fixture disclosed in the Dominguez patent, the reflecting surfaces for the artificial light are directly dependent on the shape and size of the lighting fixture. They are not independent of structure of the lighting fixture, which is undesirable.

Also, the preferred embodiment of the Dominguez lighting fixture is directional in nature. Sunlight reflects off the lid and down through the hollow light duct only when the sun is at an appropriate location in the sky. The alternative embodiment of the Dominguez lighting fixture can be rotated to track the sun, which is generally undesirable.

It is also interesting to note that this prior art lighting fixture is not useable around in climates where there is snow and ice accumulation on the roof of a building, since the lid is closed when sunlight is not required. Further, the lighting fixture disclosed in the Dominguez patent is not suitable for installation into a wall, only into a ceiling.

It is an object of the present invention to provide a lighting fixture that provides both sunlight and artificial light.

It is an object of the present invention to provide a lighting fixture that provides both sunlight and artificial light, which lighting fixture is cost effective in terms of capital cost and installation cost.

It is an object of the present invention to provide a lighting fixture that provides both sunlight and artificial light, wherein the natural light entering the building from the skylight (or window) is provided at the same location as from the artificial light source.

It is an object of the present invention to provide a lighting fixture that provides both sunlight and artificial light, which lighting fixture provides for easy maintenance.

It is an object of the present invention to provide a lighting fixture that provides both sunlight and artificial light, wherein the reflector is immediately adjacent the artificial light source.

It is an object of the present invention to provide a lighting fixture that provides both sunlight and artificial light, which lighting fixture is efficient at providing artificial light.

It is an object of the present invention to provide a lighting fixture that provides both sunlight and artificial light, wherein the reflector for the artificial light source is independent of the opening that permits sunlight to pass therethrough.

It is an object of the present invention to provide a lighting fixture that provides both sunlight and artificial light, which lighting fixture is suitable for installation into both walls and ceilings.

### SUMMARY OF THE INVENTION

In accordance with one aspect of the present invention there is disclosed a novel lighting fixture for emitting natural and artificial light into a building. The lighting fixture comprises a main frame body; means for mounting the main frame body onto a building; a light transmissive skylight mounted in generally overlying relation on the main frame body; a natural-light passing opening in the main frame body for permitting natural light received from the light transmissive skylight to pass through the main frame body and into the building; a first light socket operatively mounted on the main frame body for receiving an artificial light source therein; and a reflector means operatively mounted on the main frame body adjacent the first light socket in overlying relation thereto, for reflecting artificial light from the artificial light source outwardly from the lighting fixture and into the building.

In accordance with another aspect of the present invention there is disclosed a novel lighting fixture for emitting natural and artificial light into a building. The lighting fixture comprises, in seriatim, a light transmissive skylight, a main frame body, a reflector means, and a first light socket for receiving an artificial light source therein. There is also means to mount the main frame body onto a building. The main frame body has a natural-light passing opening therein for permitting natural light received from the light transmissive skylight to pass through the main frame body and into the building, and the reflector means is for reflecting artificial light from the artificial light source outwardly from the lighting fixture and into the building.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the lighting fixture according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a perspective view of the preferred embodiment of the lighting fixture according to the present invention;

FIG. 2 is an exploded perspective view of the preferred embodiment lighting fixture of FIG. 1;

FIG. 3 is a top plan view of the preferred embodiment lighting fixture of FIG. 1;

FIG. 4 is a bottom plan view of the preferred embodiment lighting fixture of FIG. 1;

FIG. 5 is a side elevational view of the preferred embodiment lighting fixture of FIG. 1, in situ in a building;

FIG. 6 is a end elevational view of the preferred embodiment lighting fixture of FIG. 1, in situ in a building;

FIG. 7 is a sectional end elevational view of the preferred embodiment lighting fixture of FIG. 1, taken along section line 7-7 of FIG. 1, in situ in a building;

FIG. 8 is a sectional end elevational view of the preferred embodiment lighting fixture of FIG. 1, taken along section line 8-8 of FIG. 1, in situ in a building;

FIG. 9 is an enlarged sectional view of an upper end portion of FIG. 7, in situ in a building;

FIG. 10 is an enlarged sectional view of a lower end portion of FIG. 7, in situ in a building;

FIG. 11 is a perspective view of an alternative embodiment of the lighting fixture according to the present invention; and

FIG. 12 is a cross-sectional view of the alternative embodiment lighting fixture of FIG. 11 taken along section line 11-11.

### DETAILED DESCRIPTION OF THE PREFERRED AND ALTERNATIVE EMBODIMENTS

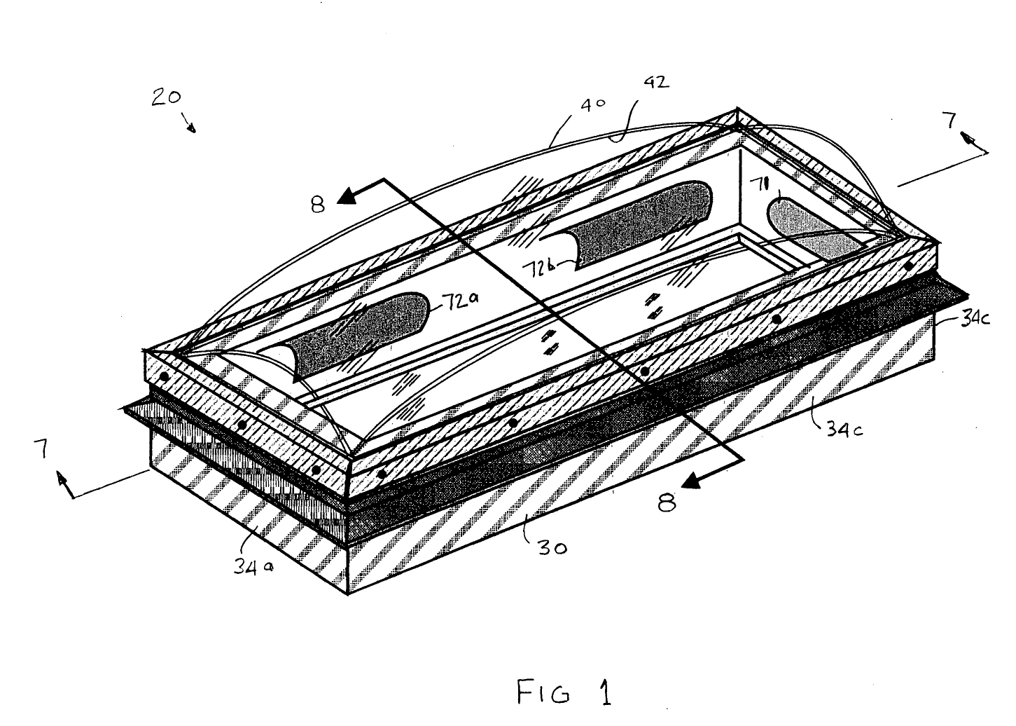

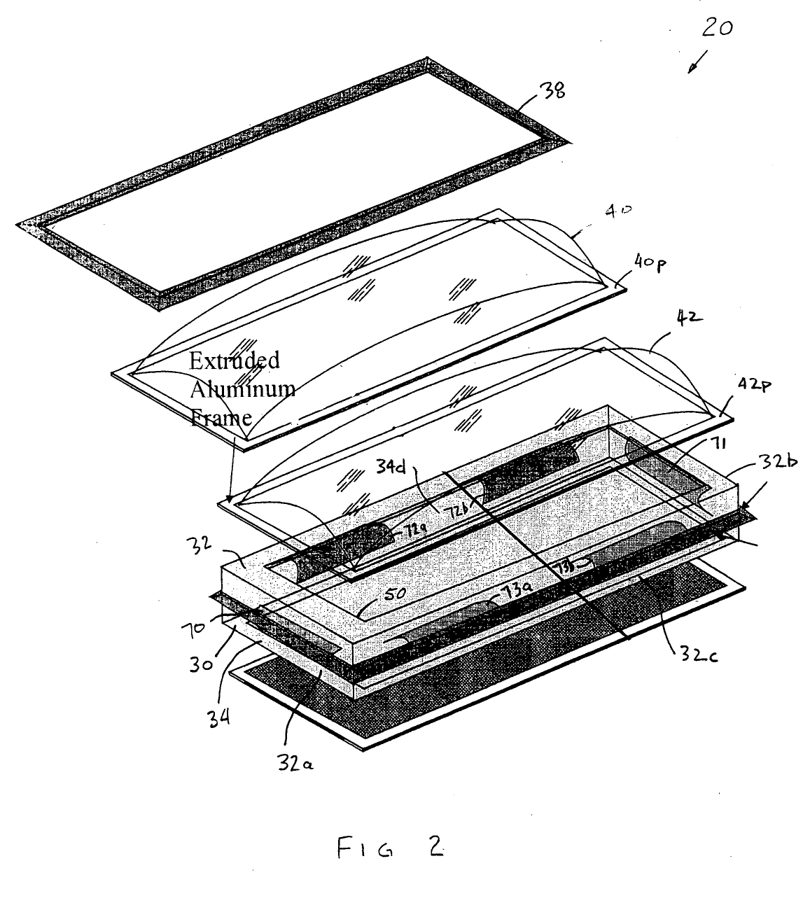

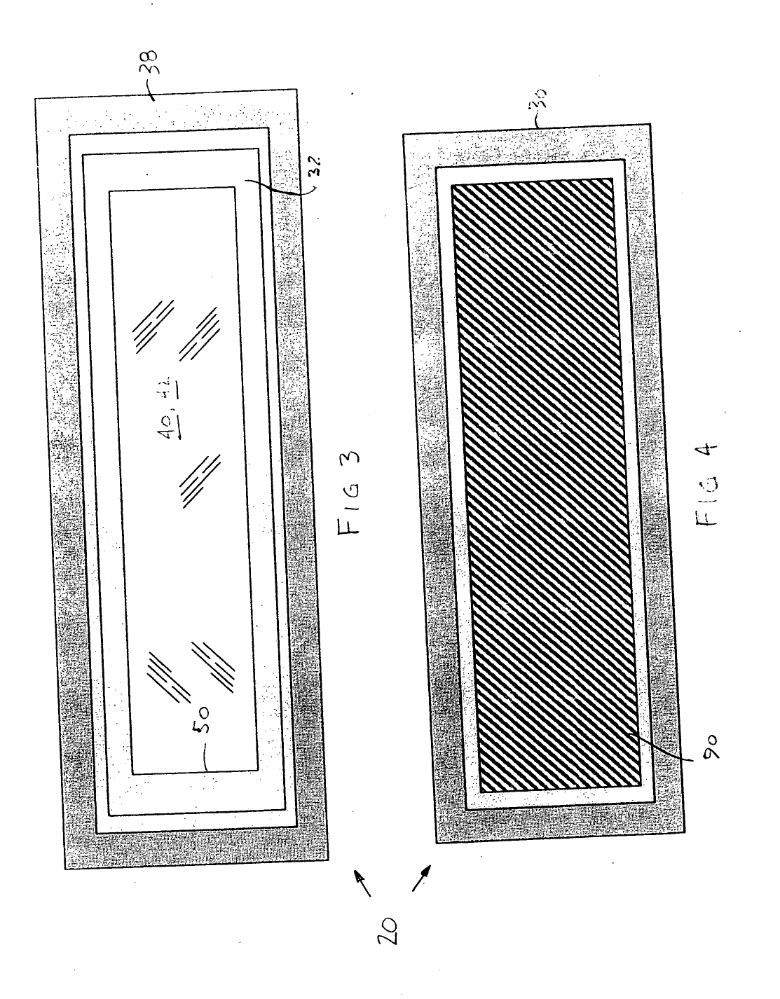

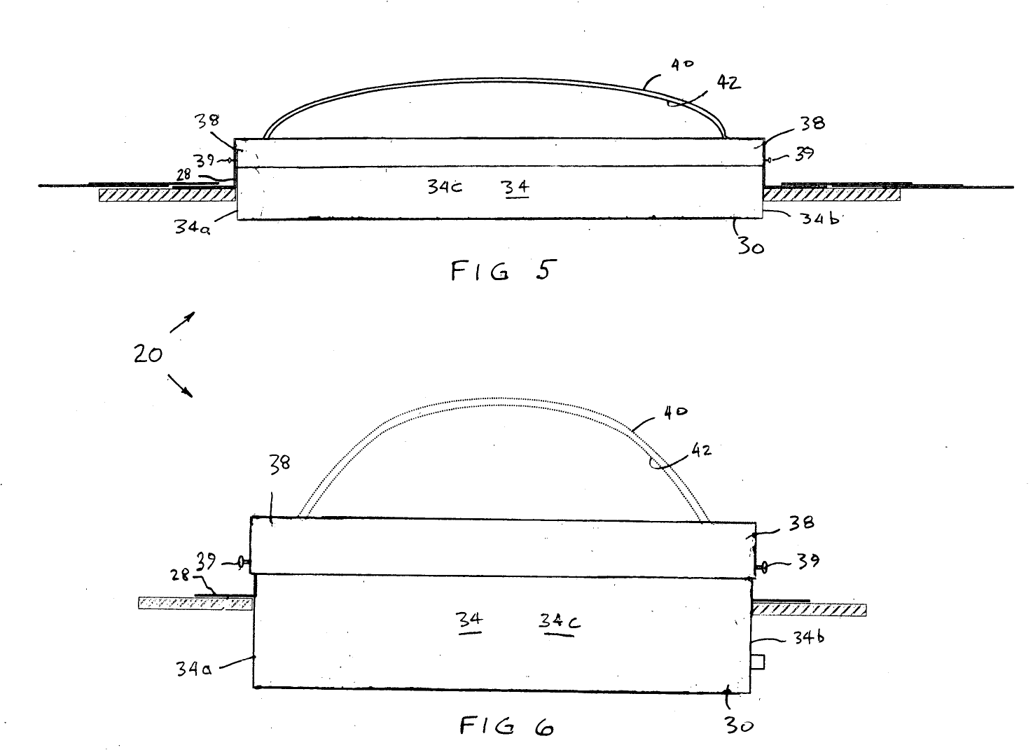

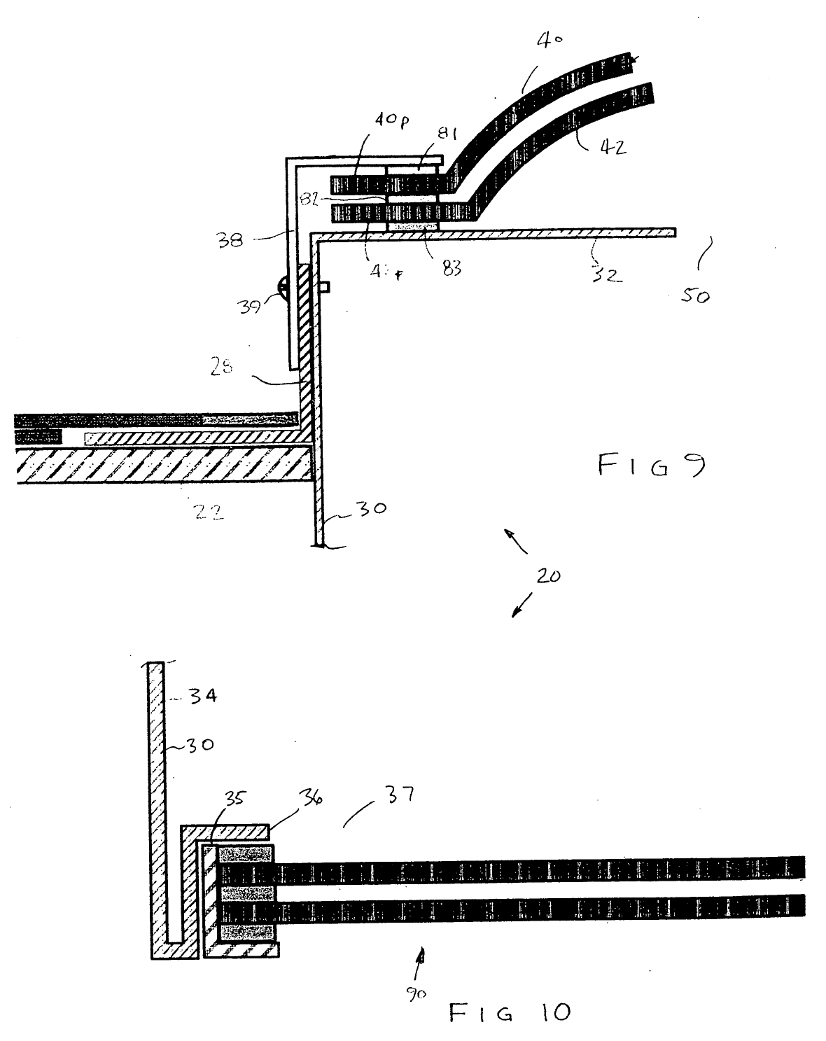

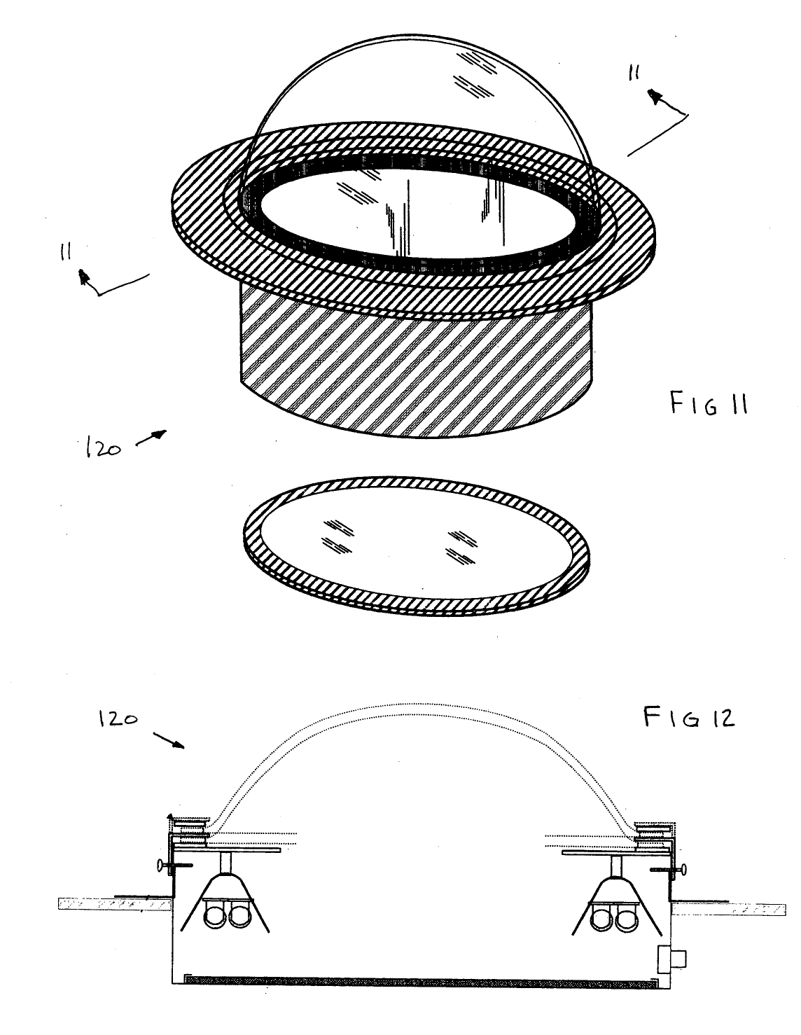

Referring to FIGS. 1 through 12 of the drawings, it will be noted that FIGS. 1 through 10 illustrate a preferred embodiment of the lighting fixture of the present invention, and FIGS. 11 and 12 illustrate an alternative embodiment of the lighting fixture of the present invention.

Reference will now be made to FIGS. 1 through 10, which show a first preferred embodiment of the lighting fixture of the present invention, as indicated by general reference numeral 20. The preferred embodiment lighting fixture 20 is for emitting natural and artificial light into a building 22.

Briefly, the preferred embodiment lighting fixture 20 comprises a main frame body 30, means for mounting the main frame body 30 onto a building 22, upper and lower light transmissive skylight domes 40,42, a natural-light passing opening 50 in the main frame body 30, a first light socket 60 and a reflector means 70.

The lighting fixture 20 comprises a main frame body 30 having a roof portion 32 and a wall portion 34 depending from the roof portion 32. The roof portion 32 is disposed around the natural-light passing opening 50 and the first light socket 60 is mounted below the roof portion 32.

In the preferred embodiment, as illustrated, the main frame body 30 is substantially rectangular and the wall portion 34 comprises a first end wall portion 34a, a second end wall portion 34b, a first side wall portion 34c, and a second side wall portion 34d. The wall portion 34 terminates in a peripheral outer edge 36 that defines a combined-light passing opening 37.

The lighting fixture 20 further comprises a peripheral retaining frame 38 secured by threaded fasteners 39 against the first and second end wall portions 34a, 34b and the first and second side wall portions 34c, 34d, in generally overlying relation to the main frame body 30.

There is also means for mounting the main frame body 30 onto a building 22, either in the roof or in a wall. In the preferred embodiment, as illustrated, the means for mounting the main frame body 30 onto a building 22 comprises a mounting flange 28 secured to the main frame body 30 along each end of the first and second end wall portions 34a, 34b and each of the first and second side wall portions 34c, 34d.

The upper light transmissive skylight dome 40 and a lower light transmissive skylight dome 42 are each made from an opal diffusing material (plastic or glass) for maximum efficiency, and are mounted in generally overlying relation on the main frame body 30. Each of the upper and lower light transmissive skylight domes 40, 42 has a peripheral flange portion 40p, 42p, respectively, which peripheral flange portions are substantially planar and are about one to two inches wide. As can be best seen in FIG. 8, the peripheral flange portions 40p, 42p, are securely trapped between the peripheral retaining frame 38 and the main frame body 30. A first breathable seal 81 is disposed between the peripheral retaining frame 38 and the upper light transmissive skylight dome. A second breathable seal 82 is disposed between the upper light transmissive skylight dome and the lower light transmissive skylight dome. A third breathable seal 83 is disposed between the lower light transmissive skylight dome and the roof portion 32 of the main frame body 30. The first, second and third breathable seals 81, 82, 83 are preferably made from Dacron®, or any other suitable material.

The natural-light passing opening 50 in the main frame body 30 is substantially centrally disposed in the roof portion 32 of the main frame body 30, and is for permitting natural light received from the light transmissive skylight to pass through the main frame body 30 and into the building 22.

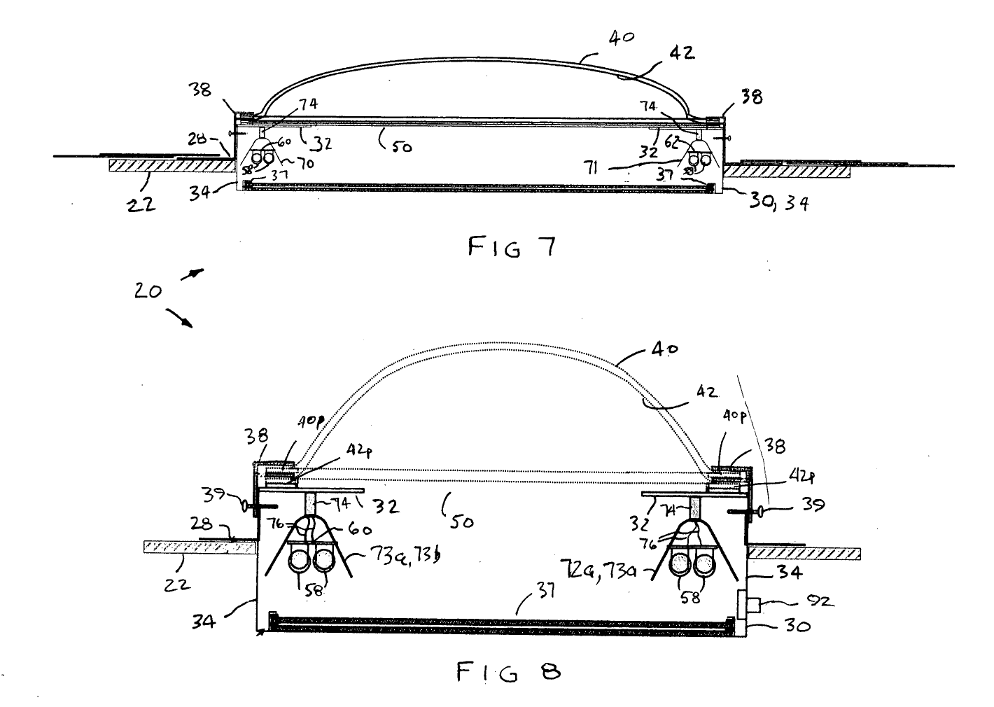

The first light socket 60 and a second light socket 62 are each operatively mounted on the main frame body 30 below the natural-light passing opening 50, each for receiving an artificial light source 58 therein, such as a fluorescent light bulb, or any other suitable light source. As can be best seen in FIG. 7, the wall portion 34 is disposed in surrounding relation around the first and second light sockets 60, 62. Also, the natural-light passing opening 50 is disposed between the first light socket 60 and the second light socket 62.

The reflector means 70 comprises a first metal reflector 71 and a second metal reflector 72 that are operatively mounted on the main frame body 30, adjacent the first light socket 60 in overlying relation thereto. The first and second metal reflectors 72, 72 are for reflecting artificial light from the artificial light source 58 outwardly from the lighting fixture 20 and into the building 22. The first and second metal reflectors 71, 72 are oriented to reflect artificial light from the artificial light source 58 substantially directly through the combined-light passing opening 37.

In the preferred embodiment, as illustrated, the reflector means 70 are mounted directly on the roof portion 32 of the main frame body 30 by means of a mounting bracket 74. The electrical wires 76 pass through the mounting bracket 74 and run to the first and second light sockets 60, 62, which are directly mounted on the reflector means 70.

There is also a light diffuser, as indicated by general reference numeral 90, mounted on the main frame body 30 at the bottom opening, to diffuse both the natural and artificial light provided by the lighting fixture 20 of the present invention. As is best seen in FIG. 10, the light diffuser 90 is mounted in place in a co-operating recess 35 by means of suitable fasteners (not shown) or possibly by a hinge (not shown) on one end and a catch mechanism (not shown) on the opposite other end.

Optionally, there is a photocell 92 mounted on the main frame body 30 and electrically connected to the artificial light source 58, as is best seen in FIG. 8, for turning on and off the artificial light source 58 according to the amount of natural light passing through the lighting fixture 20.

It can also be seen from the drawings that the lighting fixture 20 according to the present invention comprises in seriatim, a light transmissive skylight, a main frame body 30, a reflector means 70, and a first light socket 60 for receiving an artificial light source 58 therein.

It should also be noted that there is no hingeable lid as is necessary in the above referenced prior art. Accordingly, the lighting fixture of the present invention is not directional in nature.

Reference will now be made to FIGS. 11 through 12, which show an alternative embodiment of the lighting fixture of the present invention, as indicated by general reference numeral 120. The alternative embodiment lighting fixture 120 is similar to the preferred embodiment lighting fixture 20 except that instead of being rectangular in shape, it is circular in shape. Other shapes are also possible without departing from the scope and spirit of the present invention.

As can be understood from the above description and from the accompanying drawings, the present invention provides a lighting fixture that provides both sunlight and artificial light, which lighting fixture is cost effective in terms of capital cost and installation cost, wherein the natural light entering the building from the skylight (or window) is provided at the same location as from the artificial light source, which lighting fixture provides for easy maintenance, wherein the reflector is immediately adjacent the artificial light source, which lighting fixture is efficient at providing artificial light, wherein the reflector for the artificial light source is independent of the opening that permits sunlight to pass therethrough, and which lighting fixture is suitable for installation into both walls and ceilings, all of which features are unknown in the prior art.

Other variations of the above principles will be apparent to those who are knowledgeable in the field of the invention, and such variations are considered to be within the scope of the present invention. Further, other modifications and alterations may be used in the design and manufacture of the lighting fixture of the present invention without departing from the spirit and scope of the accompanying claims.

1. A lighting fixture for emitting natural and artificial light into a building, said lighting fixture comprising:
a main frame body;
means for mounting said main frame body onto a building;
a light transmissive skylight mounted in generally overlying relation on said main frame body;
a natural-light passing opening in said main frame body for permitting natural light received from said light transmissive skylight to pass through said main frame body and into said building;
a first light socket operatively mounted on said main frame body for receiving an artificial light source therein; and,
a reflector means operatively mounted on said main frame body adjacent said first light socket in overlying relation thereto, for reflecting artificial light from said artificial light source outwardly from said lighting fixture and into said building.

2. The lighting fixture of claim 1, wherein said reflector means is mounted on said main frame body.

3. The lighting fixture of claim 2, wherein said first light socket is mounted on said reflector means.

4. The lighting fixture of claim 1, wherein said main frame body has a roof portion and a wall portion depending from said roof portion.

5. The lighting fixture of claim 4, wherein said wall portion terminates in a peripheral outer edge that defines a combined-light passing opening.

6. The lighting fixture of claim 5, wherein said reflector means is oriented to reflect artificial light from said artificial light source substantially directly through said combined-light passing opening.

7. The lighting fixture of claim 6, wherein said natural-light passing opening is disposed in said roof portion of said main frame body.

8. The lighting fixture of claim 7, wherein said natural-light passing opening is substantially centrally disposed in said roof portion of said main frame body.

9. The lighting fixture of claim 8, wherein said roof portion has perimeter portion disposed around said natural-light passing opening and said first light socket is mounted below said perimeter portion.

10. The lighting fixture of claim 9, wherein said first light socket is operatively mounted below said natural-light passing opening.

11. The lighting fixture of claim 4, wherein said wall portion is disposed in surrounding relation around said first light socket.

12. The lighting fixture of claim 4, wherein said main frame body is substantially rectangular and said wall portion comprises a first end wall portion, a second end wall portion, a first side wall portion, and a second side wall portion.

13. The lighting fixture of claim 1, further comprising a second light socket operatively mounted on said main frame body for receiving an artificial light source therein.

14. The lighting fixture of claim 13, wherein said natural-light passing opening is disposed between said first light socket and said second light socket.

15. The lighting fixture of claim 1, further comprising a peripheral retaining frame secured in generally overlying relation to said main frame body.

16. The lighting fixture of claim 15, wherein said light transmissive skylight has a peripheral flange portion and said peripheral flange portion is securely trapped between said peripheral retaining frame and said main frame body body.

17. The lighting fixture of claim 1, wherein said means for mounting said main frame body onto a building comprises a mounting flange secured to said main frame body.

18. The lighting fixture of claim 1, further comprising a light diffuser mounted on said main frame body at said bottom opening.

19. The lighting fixture of claim 1, further comprising a photocell mounted on said main frame body and electrically connected to said artificial light source.

20. A lighting fixture for emitting natural and artificial light into a building, said lighting fixture comprising:
in seriatim, a light transmissive skylight, a main frame body, a reflector means, and a first light socket for receiving an artificial light source therein; and,
means to mount said main frame body onto a building;
wherein said main frame body has a natural-light passing opening therein for permitting natural light received from said light transmissive skylight to pass through said main frame body and into said building, and said reflector means is for reflecting artificial light from said artificial light source outwardly from said lighting fixture and into said building.
